(19) United States
(12) Patent Application Publication
(10) Pub. No.: US 2015/0281116 A1
(43) Pub. Date: Oct. 1, 2015

(54) METHOD FOR SETTING SENSOR NODE AND SETTING SECURITY IN SENSOR NETWORK, AND SENSOR NETWORK SYSTEM INCLUDING THE SAME

(71) Applicant: Electronics and Telecommunications Research Institute, Daejeon (KR)

(72) Inventors: Seok kap KO, Gwangju (KR); Seung-Hun OH, Gwangju (KR); Byung-Tak LEE, Suwon-si (KR); Sim-Kwon YOON, Gwangju (KR); Mun Seob LEE, Daejeon (KR); Il kyun PARK, Gwangju (KR); Young Sun KIM, Gwangju (KR)

(21) Appl. No.: 14/337,099

(22) Filed: Jul. 21, 2014

(30) Foreign Application Priority Data
Mar. 27, 2014 (KR) 10-2014-0036343

(51) Int. Cl. H04L 12/923; H04L 9/32; H04L 29/06

(52) U.S. Cl. CPC H04L 47/762; H04L 63/06; H04L 9/3271; H04L 9/3242

(57) ABSTRACT

There are provided a method for setting a sensor node and setting security in a sensor network, and a sensor network system including the same. A setting apparatus scans a near field communication apparatus included in the sensor node to obtain information on the sensor node. The information on the sensor node is transmitted to a gateway, and the gateway connects the sensor node to the sensor network using the received information on the sensor node.

### CROSS-REFERENCE TO RELATED APPLICATION

This application claims priority to and the benefit of Korean Patent Application No. 10-2014-0036343 filed in the Korean Intellectual Property Office on Mar. 27, 2014, the entire contents of which are incorporated herein by reference.

### BACKGROUND OF THE INVENTION

(a) Field of the Invention

The present invention relates to a method for setting a sensor node and setting security in a sensor network, and a sensor network system including the same.

(b) Description of the Related Art

The Internet of things indicates a network through which various things such as sensors, actuators, machines, vehicles, facilities, and the like, as well as computers and servers, are connected with each other. Sensor nodes configuring the Internet of things have smaller sizes and fewer interfaces than those of general nodes having a computer function. Therefore, it is very inconvenient to connect the sensor nodes with each other and install the sensor nodes. For example, in the case of connecting sensor nodes capable of performing Zigbee MAC/PHY communication with each other, identifiers (IDs), radio channel numbers, personal area network IDs, and the like, of the sensors should be set. In order to set them, a dedicated setting apparatus should be directly connected with the sensor node, which is inconvenient. Although the sensor node may be set using a dual in line package (DIP) switch, there are too many parameters that should be set, such that it is difficult to set the sensor node using only the DIP switch, and the DIP switch occupies much volume.

Generally, in the case of setting the sensor node using the setting dedicated apparatus, an installer opens a case of the sensor node and connects the setting dedicated apparatus with a specific connector of an internal board through a wired cable. After the setting dedicated apparatus executes a setting software program, the installer inputs various setting parameters. The installer checks whether or not the sensor node has been set well, disconnects the setting dedicated apparatus, and again assembles the case of the sensor node. In the case in which there are a large number of sensor nodes to be installed, much labor and time are consumed in the above-mentioned manual setting. In a method for manually setting a sensor node as described above, setting is troublesome, and much time is consumed.

Meanwhile, a security issue has become important in a sensor network. In order to set security in the sensor network, additional setting for security is required. Also in the security setting as described above, there are many contents to be set, such that there is a difficulty in manual setting.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for setting a sensor node in a simple scheme.

The present invention has also been made in an effort to provide a method for setting security of a sensor node in a simple scheme.

An exemplary embodiment of the present invention provides a method for setting a sensor node in a sensor network. The method includes: scanning, by a setting apparatus, the sensor node to obtain information on the sensor node; selecting a gateway that is to be connected with the sensor node; transmitting the information on the sensor node to the selected gateway; and requesting, by the selected gateway, the sensor node to make a connection.

The sensor node may include a near field communication apparatus, and the obtaining of the information on the sensor node may include scanning, by the setting apparatus, the near field communication apparatus to obtain the information on the sensor node.

The information on the sensor node may include an ID of the sensor node.

The selecting of the gateway may include: obtaining a position of the sensor node; and selecting the gateway that is to be connected with the sensor node using the obtained position.

The method may further include transmitting, by the setting apparatus, a setup request message to a managing server, wherein the transmitting of the information on the sensor node includes transmitting, by the managing server, a bind request message to the selected gateway, and the setup request message and the bind request message include the information on the sensor node.

The selecting of the gateway may include scanning, by the setting apparatus, the gateway to select the gateway.

The transmitting of the information on the sensor node may include transmitting, by the setting apparatus, a bind request message to the selected gateway, and the bind request message may include the information on the sensor node.

The setup request message may further include information on the setting apparatus, and the method may further include: transmitting, by the managing server, an authentication code to the setting apparatus using the information on the setting apparatus; and transmitting, by the setting apparatus, an acknowledge message including the authentication code to the managing server.

The method may further include: transmitting, by the managing server, a passcode to the setting apparatus and the selected gateway, wherein the bind request message further includes the passcode.

The requesting of the sensor node to make the connection may include: transmitting, by the selected gateway, an invite request message to the sensor node; transmitting, by the sensor node, a challenge message including a first random value to the selected gateway; converting, by the selected gateway, the first random value and a secret key into a first hash value using a hash function; transmitting, by the selected gateway, the first hash value to the setting apparatus; and requesting, by the setting apparatus, the selected gateway to make a connection.

The invite request message may include a second random value, and the requesting of the sensor node to make the connection may further include: converting, by the sensor node, the second random value and the secret key into a second hash value using the hash function; and transmitting, by the sensor node, the second hash value to the selected gateway.

The requesting of the sensor node to make the connection may include: transmitting, by the selected gateway, an invite request message to the sensor node; transmitting, by the setting apparatus, a challenge message including a random value and a connect message for a connection request to the selected gateway; converting, by the selected gateway, the random value and a secret key into a hash value using a hash function; and transmitting, by the selected gateway, the hash value and admittance of the connection to the setting apparatus.

The requesting of the sensor node to make the connection may include: transmitting, by the gateway, a connect message to the sensor node; transmitting, by the sensor node, a challenge message including a random value to the selected gateway; converting, by the selected gateway, the random value and a secret key into a hash value using a hash function; transmitting, by the selected gateway, the hash value to the setting apparatus; and transmitting, by the setting apparatus, an admittance message to the selected gateway.

The requesting of the sensor node to make the connection may include: transmitting, by the selected gateway, an invite request message to the sensor node; transmitting, by the setting apparatus, a challenge message including a random value and a connect message for a connection request to the selected gateway; converting, by the selected gateway, the random value and a first secret key into a hash value using a hash function; encrypting a new session key different from the first secret key using the first secret key; and transmitting, by the selected gateway, the hash value, the encrypted value, and admittance of the connection to the setting apparatus.

Another exemplary embodiment of the present invention provides a sensor network system. The sensor network system includes: a sensor node including a first near field communication apparatus; a setting apparatus scanning the first near field communication apparatus to obtain information on the sensor node; and a gateway connected with the sensor node using the information on the sensor node obtained by the setting apparatus.

The setting apparatus may select the gateway, the sensor network system may further include a managing server receiving information on the gateway and the information on the sensor node from the setting apparatus and transmitting a bind request message to the gateway, and the bind request message may include the information on the sensor node.

The gateway may include a second near field communication apparatus, and the setting apparatus may scan the second near field communication apparatus to select the gateway and transmit the information on the sensor node to the gateway.

The first and second near field communication apparatuses may each be a quick response (QR) code.

The information on the sensor node may include an ID of the sensor node and a secret key.

Yet another exemplary embodiment of the present invention provides a method for setting a sensor node in a sensor network. The method includes providing a sensor node including an active tag; scanning, by a setting apparatus, the active tag to obtain information on the sensor node; transmitting, by a managing server, information on a gateway with which the sensor node is to be connected to the setting apparatus; transmitting, by the setting apparatus, a bind request message including the information on the gateway to the sensor node; and transmitting, by the sensor node, a connect request message to the gateway using the information on the gateway.

The method may further include transmitting, by the managing server, a bind request message, which is a message informing the gateway that the sensor node performs a connection request, to the gateway.

According to an exemplary embodiment of the present invention, the sensor node is scanned using the setting apparatus, thereby making it possible to perform setting and security of the sensor node.

### BRIEF DESCRIPTION OF THE DRAWINGS

FIG. 1 is a diagram generally showing a sensor network system according to an exemplary embodiment of the present invention.

FIG. 2 is a diagram showing a method for setting a sensor node according to a first exemplary embodiment of the present invention.

FIG. 3 is a diagram showing a screen displayed by a setting apparatus.

FIG. 4 is a diagram showing a method for setting a sensor node according to a second exemplary embodiment of the present invention.

FIG. 5 is a diagram showing a method for setting security according to a first exemplary embodiment of the present invention.

FIG. 6 is a diagram showing a method for setting security according to a second exemplary embodiment of the present invention.

FIG. 7 is a diagram showing a method for setting security according to a third exemplary embodiment of the present invention.

FIG. 8 is a diagram showing a method for setting security according to a fourth exemplary embodiment of the present invention.

FIG. 9 is a diagram showing a method for setting security according to a fifth exemplary embodiment of the present invention.

FIG. 10 is a diagram showing a method for setting security according to a sixth exemplary embodiment of the present invention.

FIG. 11 is a diagram showing a method for setting a sensor node according to a third exemplary embodiment of the present invention.

FIG. 12 is a diagram showing computer system according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise” and variations such as “comprises” or “comprising” will be understood to imply the inclusion of stated elements but not the exclusion of any other elements.

In addition, throughout this specification and the claims that follow, when it is described that an element is “coupled” to another element, the element may be “directly coupled” to the other element or “electrically coupled” to the other element through a third element.

In a method for setting a sensor node according to an exemplary embodiment of the present invention, a setting apparatus scans a separate near field communication apparatus (for example, a near field communication (NFC) or a quick response (QR) code) attached to the sensor node and then automatically connects the sensor node with a sensor network. A method for setting a sensor node according to an exemplary embodiment of the present invention will be described below in detail.

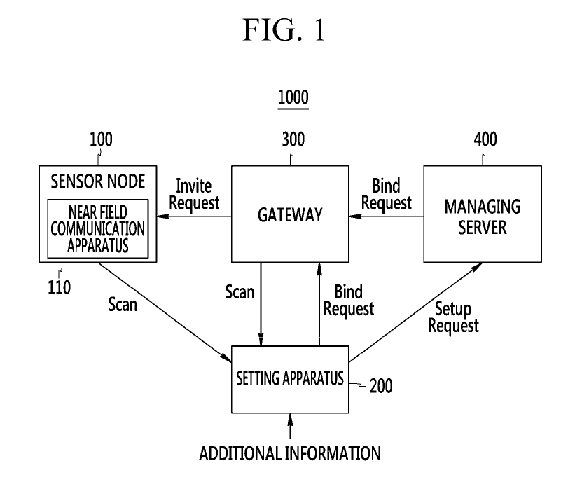

FIG. 1 is a diagram generally showing a sensor network system according to an exemplary embodiment of the present invention.

As shown in FIG. 1, the sensor network system 1000 according to an exemplary embodiment of the present invention is configured to include a sensor node 100, a setting apparatus 200, a gateway 300, and a managing server 400.

The sensor node 100 may be one that is to be newly set in a sensor network. The sensor node 100 is in a standby state in which a basic apparatus such as a power supply or the like is installed. In addition, the sensor node 100 according to an exemplary embodiment of the present invention has a near field communication apparatus 110 mounted therein. Although only the case in which the number of sensor nodes 100 is one has been shown in FIG. 1, the number of sensor nodes 100 may be plural.

The setting apparatus 200, which is an apparatus possessed by an installer installing the sensor network, is an apparatus for setting (registering) the sensor node 100 in the sensor network. The setting apparatus 200 may be implemented by a smart phone or an apparatus similar to the smart phone. Meanwhile, the setting apparatus 200 may perform communication with the near field communication apparatus 110 attached to the sensor node 100 to scan the sensor node 100. In addition, the setting apparatus 200 may be connected with the gateway 300 and the managing server 400 through a communication interface.

The gateway 300, which is a node directly connected with the sensor node 100, has an interface capable of communicating with the sensor node 100. In addition, the gateway 300 also has an interface capable of communicating with the managing server 400. For example, the gateway 300 may include a Zigbee communication interface so as to communicate with the sensor node 100, and may include an Ethernet communication interface so as to communicate with the managing server 400.

The managing server 400 is a server for generally managing the sensor network. The managing server 400 manages a kind, a function, and an installation position of the sensor node 100, information on the gateway 300 connected with the sensor node 100, and the like. The managing server 400 may provide a sensor network service to the sensor network using this information or provide this information to another application service.

In order to set (register) the sensor node 100, the installer scans the near field communication apparatus 110 mounted in the sensor node 100 using the setting apparatus 200. After the sensor node 100 is scanned, the setting apparatus 200 transmits a setup request message requesting the managing server 400 to set (register) the sensor node 100 to the managing server 400 by a manual operation (for example, an operation of pressing a ‘Connect’ button) of the installer or automatically. Here, the setup request message may include additional information such as information on a position of the setting apparatus 200, intension of the installer (for example, a gateway with which the installer is to connect), or the like.

The managing server 400 determines the gateway 300 that is to be connected with the sensor node 100 in the case in which it receives the setup request message. The managing server 400 transmits a bind request message requesting the determined gateway 300 to be connected with the sensor node 100, to the determined gateway 300.

Meanwhile, the gateway 300 that is to be connected with the sensor node 100 may be automatically determined by internal software of the setting apparatus 200 or be directly determined by the installer. In this case, the setting apparatus 200 scans the gateway 300 and then transmits the bind request message to the gateway 300.

The gateway 300 receiving the bind request message from the managing server 400 or the setting apparatus 200 transmits an invite request message to the sensor node 100 using an ID of the sensor node 100 included in the bind request message or information required for a connection.

The sensor node 100 receiving the invite request message performs a procedure in which it is connected with the gateway 300. Meanwhile, the installer may confirm whether or not the setting (registration) of the sensor node 100 has been completed to the gateway 300 or the managing server 400 using the setting apparatus 200.

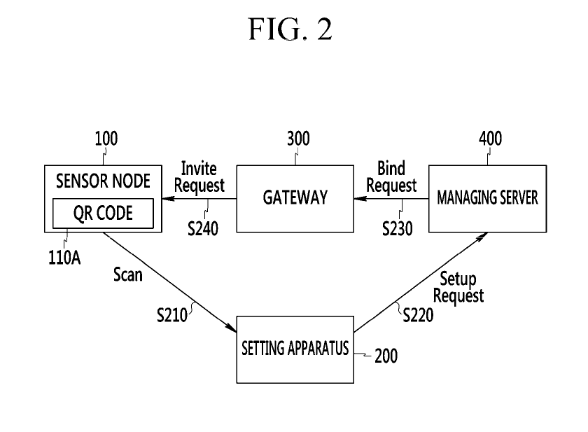

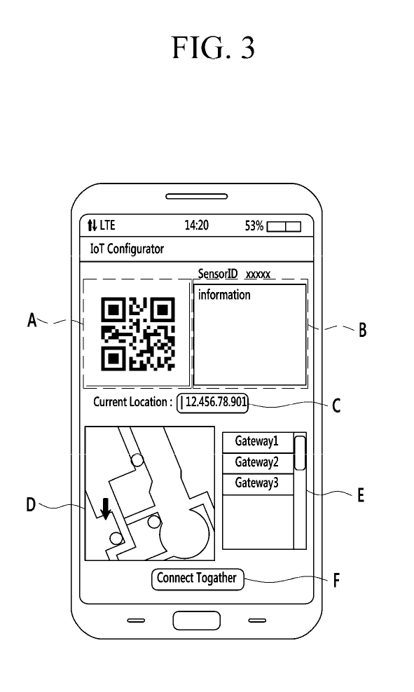

Hereinafter, a method for setting a sensor node according to a first exemplary embodiment of the present invention will be described with reference to FIGS. 2 and 3. A method for setting a sensor node according to a first exemplary embodiment of the present invention is one in which the sensor node 100 is set through the managing server 400.

FIG. 2 is a diagram showing a method for setting a sensor node according to a first exemplary embodiment of the present invention.

First, it is assumed that basic hardware is installed in a new sensor node 100 (that is, a state in which a power supply is connected and fixing is completed). In addition, in FIG. 2, for convenience of explanation, the case in which the near field communication apparatus 110 is a quick response (QR) code will be described by way of example.

A QR code 110A may be installed outside, inside, or around the sensor node 100.

The installer positions the setting apparatus 200 in the vicinity of the sensor node 100, and scans the QR code 110A of the sensor node 100 using a camera mounted in the setting apparatus (S210). Here, the QR code 110A includes an ID of the sensor node 100. In addition, the QR code 110A may further include a channel number for setting, a personal area network (PAN) ID for setting, and a connection key code (secret key) as additional connection information.

After the scan of the sensor node 100 is completed, the setting apparatus 200 obtains current position information of the sensor node 100 using a global positioning system (GPS), an indoor positioning technology, or the like. The setting apparatus 200 may obtain the current position information in advance. Since a method in which the setting apparatus 200 obtains the current position information using the GPS or the indoor positioning technology may be easily appreciated by those skilled in the art to which the present invention pertains, a detailed description thereof will be omitted. The setting apparatus 200 may display a list of adjacent gateways on a screen using the obtained current position information. This gateway list may be positioned in a separate server (not shown in FIG. 2), and the setting apparatus 200 accesses this server to display the gateway list on the screen. The gateway list may include a gateway ID and information on a position at which the gateway is installed. The gateway list corresponds to a gateway with which the sensor node 100 may be connected. The gateway list may be one gateway or a plurality of gateways.

FIG. 3 is a diagram showing a screen displayed by a setting apparatus 200.

As shown in FIG. 3, the setting apparatus 200 displays the scanned QR code A and a content B in which the QR code is decoded. In addition, the setting apparatus 200 displays the obtained current position information C and displays the gateway with which the sensor node 100 may be connected on a map D. The setting apparatus 200 also displays the gateway list E. Meanwhile, the installer selects one of gateways in the gateway list E and then presses a connect button F positioned at a lower portion of the screen.

When the installer presses the connect button F of the setting apparatus 200, the setting apparatus 200 transmits a setup request message to the managing server 400 (S220). The setup request message includes an ID of the sensor node 100, information on the selected gateway, and additional connection information.

The managing server 400 receiving the setup request message from the setting apparatus 200 confirms gateway information (a network address of the gateway 300) and then transmits a bind request message to the gateway 300 (S230). Here, the bind request message may include the ID of the sensor node 100 and additional connection information.

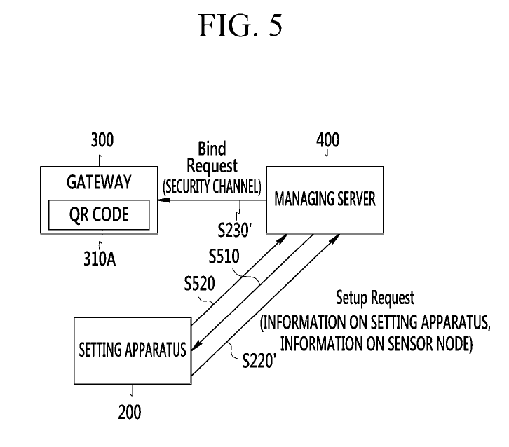

The gateway 300 receiving the bind request message transmits an invite request message requesting the sensor node 100 to be connected therewith to the sensor node 100 (S240). Here, the gateway 300 may perform a network connection and a security connection with the sensor node 100 using the additional connection information (that is, a channel number for setting, a PAN ID for setting, a connection key code (secret key), and the like). A security connection method will be described below in detail with reference to FIGS. 5 to 10.

The sensor node 100 receives the invite request message from the gateway 300, sets a sensor network, and performs a connection with the gateway 300. The sensor node 100 performs the connection with the gateway 300 and then performs the security connection. Meanwhile, after the connection of the sensor node 100 is completed, the sensor node 100 or the gateway 300 informs the managing server 400 that the connection (setting or registration) of the new sensor node 100 has been completed. In addition, the installer may recognize that the connection has been completed from the managing server 400.

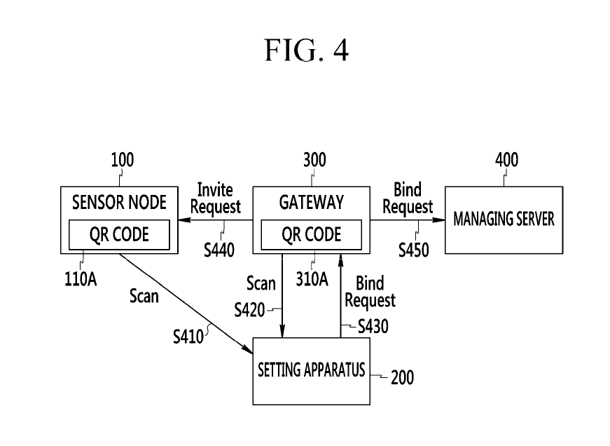

Meanwhile, a method other than a method in which the installer selects the gateway in the gateway list as described above may be used. The installer allows the setting apparatus 200 to approach the gateway 300 to scan the QR code of the gateway 300. The setting apparatus 200 may select the gateway that is to be connected through the above-mentioned scan process, and may directly transmit the setup request message to the gateway 300. Hereinafter, a method for setting a sensor node according to a second exemplary embodiment of the present invention, which is the current method, will be described in detail with reference to FIG. 4.

FIG. 4 is a diagram showing a method for setting a sensor node according to a second exemplary embodiment of the present invention. The method for setting a sensor node according to a second exemplary embodiment of the present invention corresponds to the case in which communication between the gateway 300 and the setting apparatus 200 is possible. That is, a near field communication apparatus is also mounted in the gateway 300. In FIG. 4, for convenience of explanation, the case in which the near field communication apparatus mounted in the gateway 300 is a QR code will be described by way of example.

First, as in the first exemplary embodiment of the present invention of FIG. 2, the installer scans a QR code 110A of the sensor node 100 using the setting apparatus 200 (S410). Since S410 is the same as S210, an overlapped description will be omitted.

Next, the installer allows the setting apparatus 200 to approach the gateway 300 to scan a QR code 310A of the gateway 300 (S420).

Then, the setting apparatus 200 transmits a bind request message to the gateway 300 (S430). Here, the bind request message may include the ID of the sensor node 100 and additional connection information as in the case of FIG. 2.

Meanwhile, as a modification of S420 and S430, S420 may be omitted in the case in which the setting apparatus 200 already has information on a gateway that is scanned. Here, the setting apparatus 200 may transmit the bind request message to the gateway 300 by confirmation of the installer or automatically.

The gateway 300 receiving the bind request message transmits an invite request message requesting the sensor node 100 to be connected therewith to the sensor node 100 (S440). That is, S440 is the same as S240.

The sensor node 100 receives the invite request message from the gateway 300, sets a sensor network, and performs a connection with the gateway 300. The sensor node 100 performs the connection with the gateway 300 and then performs the security connection.

After the connection of the sensor node 100 is completed, the sensor node 100 or the gateway 300 transmits a bind report message reporting that the connection of the sensor node has been completed to the managing server 400 (S450). In addition, the installer may recognize that the connection has been completed from the managing server 400.

In addition to the QR code scheme, various near field communication schemes such as a barcode scheme, a marker scheme, a near field communication (NFC) scheme, a radio frequency identification (RFID) scheme, and the like, may be used as a scan scheme in S210 and S420 described above. In addition, the scan scheme may be implemented using a high level image recognizing technology using figure or letter recognition.

Meanwhile, the scan scheme according to an exemplary embodiment of the present invention may be implemented using a DIP switch. In the case in which the setting apparatus 200 is implemented by a smart phone, a sensor ID and a setting parameter may be obtained by recognizing setting of the DIP switch attached to the sensor node using an image technology of the smart phone.

Hereinafter, a method for setting security according to an exemplary embodiment of the present invention will be described. A method for setting security according to an exemplary embodiment of the present invention may be performed after the method for setting a sensor node according to an exemplary embodiment of the present is performed, or may be performed simultaneously with the method for setting a sensor node according to an exemplary embodiment of the present invention.

Hereinafter, a method for setting security according to a first exemplary embodiment of the present invention will be described with reference to FIG. 5. A method for setting security according to a first exemplary embodiment of the present invention is a method in which the managing server 400 authenticates the setting apparatus 200. In S220 of FIG. 2, the managing server 400 receives the setup request message from the setting apparatus 200. In this case, the managing server 400 needs to confirm whether the setting apparatus 200 is a correct apparatus and whether the setup request message is a correct message.

FIG. 5 is a diagram showing a method for setting security according to a first exemplary embodiment of the present invention.

First, in S210 of FIG. 2, the setting apparatus 200 scans the sensor node 100 and obtains a sensor ID and information on the managing server 400.

Referring to FIG. 5, the setting apparatus 200 connects the sensor node 100 with the managing server 400 and transfers a setup request message so as to set security with the sensor node 100 (S220′). The setup request message includes information (for example, a phone number) of the setting apparatus 200 and information (a sensor ID, a security key, and the like) on the sensor node 100. Meanwhile, in the case in which the setting apparatus is implemented by a smart phone, the setup request message may be transferred to the managing server 400 through a mobile communication network.

Next, the managing server 400 performs a procedure of confirming whether the setting apparatus 200 is a reliable apparatus. The managing server 400 transmits a text message (for example, a short message service (SMS) or multimedia message service (MMS) text message) including an authentication code to the setting apparatus 200 using the phone number of the setting apparatus 200 included in the setup request message (S510).

The setting apparatus 200 receiving the text message transmits an acknowledge message including an authentication code to the managing server 400 (S520).

The managing server 400 completes authentication for the setting apparatus 200 through whether or not the authentication code received in S520 is the authentication code transmitted in S510. In addition, the managing server 400 transmits a bind request message, which is a message instructing the gateway 300 to start a connection of the sensor node 100, to the gateway 300 (S230′). Here, the bind request message transmitted to the gateway 300 may be transferred through a security channel (for example, an IP security protocol (IPSEC), a transport layer security (TLS), or the like).

Meanwhile, in addition to a method through the text message including the authentication code described above with reference to FIG. 5, a method of confirming an international mobile subscriber identity (IMSI) or an international mobile equipment identify (IMEI), a method of using a password, or the like, is possible.

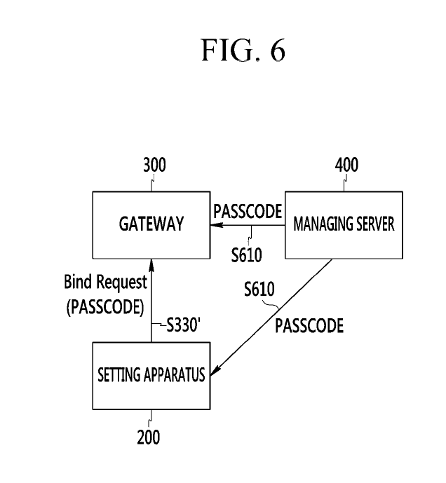

A method for setting security according to a second exemplary embodiment of the present invention will be described with reference to FIG. 6. A method for setting security according to a second exemplary embodiment of the present invention is a method in which the gateway 300 authenticates the setting apparatus 200. In S430 of FIG. 4, the setting apparatus 200 transmits the bind request message to the gateway 300. In this case, authentication for the bind request message is required in the gateway 300.

FIG. 6 is a diagram showing a method for setting security according to a second exemplary embodiment of the present invention.

First, the managing server 400 provides a passcode to the gateway 300 and the setting apparatus 200 in advance (S610). Here, the passcode may be transferred through direct connection or a security channel (IPSET or TLS). Through this, the gateway 300 and the setting apparatus 200 have the same passcode.

The setting apparatus 200 transmits a bind request message including the passcode to the gateway 300 (S430′). In the case in which the passcode is included in the bind request message, it indicates that the bind request message is a reliable message.

Meanwhile, when the setting apparatus 200 transmits the bind request message including the passcode, it may transmit the bind request message using a security channel. In addition, the setting apparatus 200 may convert the passcode and a random value (or a sensor ID) using a hash function, allow the converted passcode and random value to be included in the bind request message, and transmit the bind request message including the passcode and the random value. In this case, the gateway 300 calculates a hash value by the same method and confirms that the message is correct in the case in which the calculated hash value is the same as a hash value included in the bind request message.

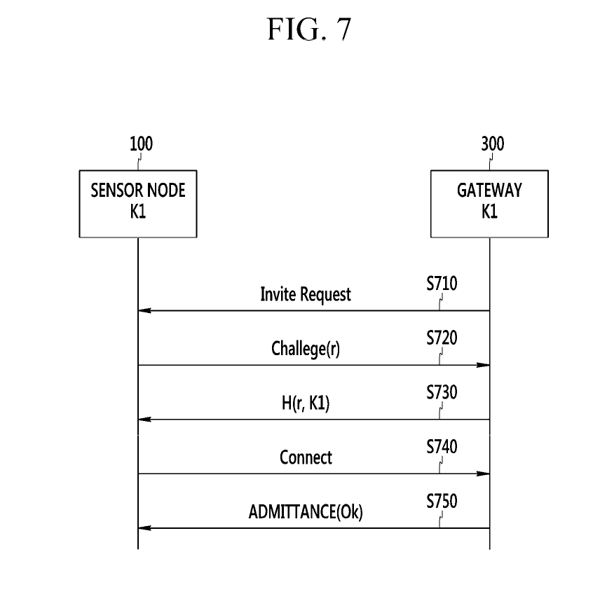

A method for setting security according to a third exemplary embodiment of the present invention will be described with reference to FIG. 7. A method for setting security according to a third exemplary embodiment of the present invention is a method in which the gateway 300 performs authentication at the time of transmitting an invite request message to the sensor node 100. In S240 of FIG. 2 or S440 of FIG. 4, the gateway 300 transmits the invite request message to the sensor node 100. In this case, the sensor node 100 needs to perform authentication for the invite request message transmitted from the gateway 300.

FIG. 7 is a diagram showing a method for setting security according to a third exemplary embodiment of the present invention.

As described above, the QR code 110A of the sensor node 100 includes the secret key K1 (that is, the connection key code) used to perform the authentication at the time of the connection request. In S210 of FIG. 2 or S410 of FIG. 4, the setting apparatus 200 obtains the connection key code (that is, the secret key) as the additional connection information and then transfers the connection key code to the gateway 300. Through this, the sensor node 100 and the gateway 300 obtain the same secret key K1 (connection key code).

Referring to FIG. 7, the gateway 300 transmits an invite request message to the sensor node 100 (S710). S710 corresponds to S240 of FIG. 2 or S440 of FIG. 4.

The sensor node 100 transmits a challenge message including a random value r to the gateway 300 in order to authenticate the invite request message (S720).

The gateway 300 converts the received random value and a secret key K1 that it possesses in advance using a hash function. The gateway 300 transmits the converted hash value H(r,K1) to the sensor node 100 (S730).

The sensor node 100 also calculates a hash value using a secret key that it possesses in advance and a hash function. Then, the sensor node 100 compares the calculated hash value and the hash value received from the gateway 300 with each other, and transmits a connect message to the gateway 300 (S740) in the case in which the hash values are the same as each other.

Next, the gateway 300 admits a connection with respect to the connect message (S750).

In FIG. 7, a process in which the sensor node 100 authenticates the gateway 300 and a process in which the gateway 300 authenticates the sensor node 100 may be simultaneously performed. In S710, the gateway 300 transmits a random value r2 (r2 is a random value different from r1) together with the invite request message at the time of transmitting the invite request message. The sensor node 100 converts the received random value r2 and the secret key K1 using the hash function, and transmits a challenge message including the converted hash value H(r2, K1). Here, the challenge message also includes a random value r. The gateway 300 performs hash on the hash value included in the challenge message using the random value r2 and the secret key K1 that it possesses to verify the sensor node 100. S730 to S750, which are the following operations, are similarly performed.

Meanwhile, in a process of FIG. 7, channel switching of the sensor network may be performed. The sensor node 100 waits to receive the invite request message while using a standby channel and PAN ID for setting. The invite request message received from the gateway 300 includes a new channel ID and a PAN ID. The sensor node 100 receives the invite request message and changes a channel into a new channel included in the invite request message in the case in which the authentication processes (S720 and S730) of FIG. 7 are completed. In addition, the sensor node 100 transmits a connect message to the gateway 300 using the changed channel.

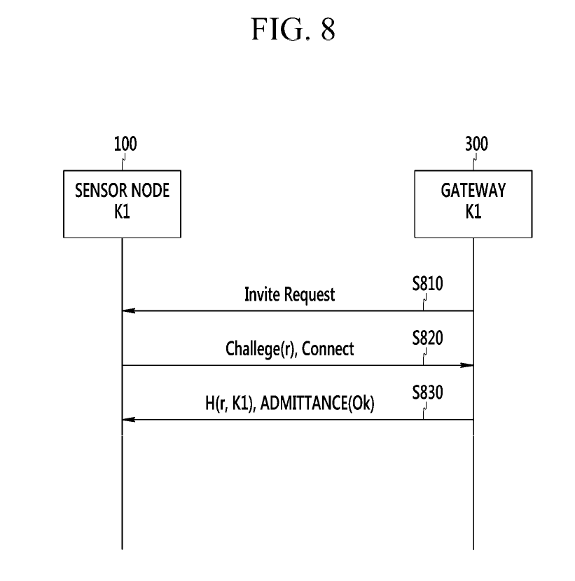

FIG. 8 is a diagram showing a method for setting security according to a fourth exemplary embodiment of the present invention. S720 to S750 of FIG. 7 may be reduced, and FIG. 8 is a diagram showing these reduced steps.

The sensor node 100 transmits a connect message together with a challenge message including a random value r to the gateway 300 in order to authenticate an invite request message (S820).

The gateway 300 converts a secret key and a random value that it possesses in advance using a hash function. In this case, the gateway 300 transmits admittance of the connection together with the converted hash value H(r,K1) to the sensor node 100 (S830).

That is, in the method for setting security according to a fourth exemplary embodiment of the present invention, a challenge process and a connect process may be simultaneously performed.

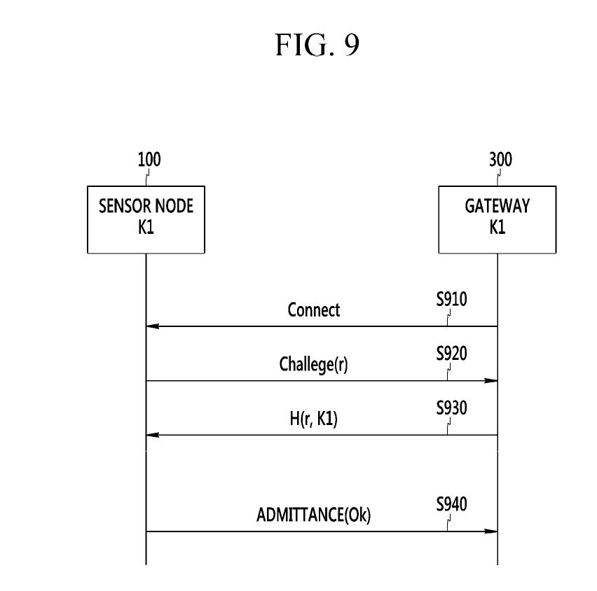

FIG. 9 is a diagram showing a method for setting security according to a fifth exemplary embodiment of the present invention.

Referring to FIG. 9, the gateway 300 directly transmits a connect message to the sensor node 100 (S910).

The sensor node 100 receiving the connect message transmits a challenge message including a random value r to the gateway 300 (S920).

The gateway 300 converts the received random value and a secret key K1 that it possesses in advance using a hash function. The gateway 300 transmits the converted hash value H(r,K1) to the sensor node 100 (S930).

The sensor node 100 also calculates a hash value using a secret key that it possesses in advance and a hash function. Then, the sensor node 100 compares the calculated hash value and the hash value received from the gateway 300 with each other, and transmits an admittance (Ok) message to the gateway 300 (S940) in the case in which the hash values are the same as each other.

For security communication, the gateway 300 may generate a new session key Ks and transfer the new session key Ks to the sensor node 100. The gateway 300 may use the new session key Ks for encryption communication or message authentication.

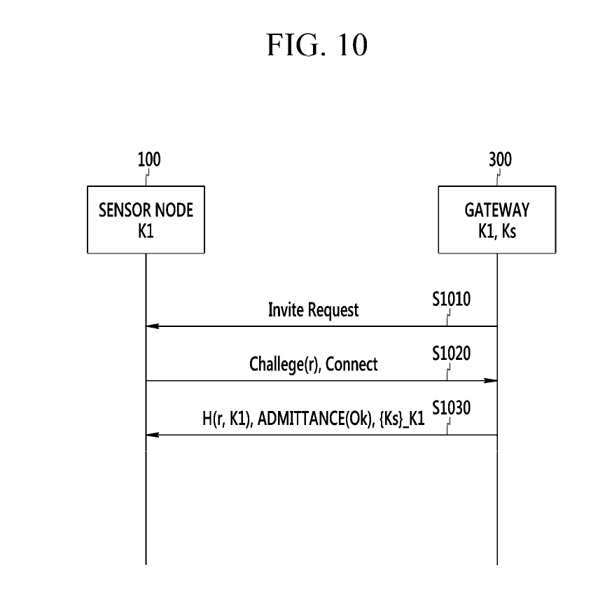

FIG. 10 is a diagram showing a method for setting security according to a sixth exemplary embodiment of the present invention. That is, FIG. 10 is a diagram showing a message flow for generating a new session key Ks for security communication and exchanging the session key Ks.

The gateway 300 transmits an invite request message to the sensor node 100 (S1010).

The sensor node 100 transmits a connect message together with a challenge message including a random value r to the gateway 300 in order to authenticate an invite request message (S1020).

The gateway 300 converts a secret key and a random value that it possesses in advance using a hash function. The gateway 300 transmits admittance of the connection together with the converted hash value H(r,K1) to the sensor node 100 (S1030). In this case, the gateway 300 encrypts the new session key Ks using the previous secret key K1 and transmits the encrypted value {Ks}_K1 to the sensor node 100 (S1030).

Through this, the gateway 300 and the sensor node 100 may share the new session key Ks with each other to perform the secure communication.

Meanwhile, in a message flow of FIGS. 7 to 10, a method of using a symmetric key has been described. An asymmetric key encryption method may be used by allowing a public key to be included in information obtained at the time of scanning the sensor node 100. When the gateway 300 transfers an initial session (for example, at the time of transmitting an invite request), the initial session is encrypted using the public key obtained from the setting apparatus 200. The sensor node 100 decrypts the session key using a secret key (private key), thereby making it possible to obtain the session key. Meanwhile, also in a process of transmitting a challenge message, instead of the hash function, the gateway 300 encrypts the random value using the public key, and the sensor node 100 decrypts the random value using the secret key, thereby making it possible to authenticate the message.

When the setting apparatus 200 scans the sensor node 100, the information obtained through the near field communication apparatus 110 (for example, the QR code) of the sensor node 100 includes contents of the following Table 1. Here, a sensor node ID may be included as necessary information.

TABLE 1

| Necessary Information | Sensor Node ID |
|---|---|
| Additional Information | Server Information: Managing Server URL |
| | Setting Connection Information: Channel ID, |
| | PAN ID, Network Address |
| | Security Connection Information: Symmetric |
| | Secret Key, Asymmetric Public Key |
| | Node Attribute Information: Kind, Name, Support |
| | Parameter List |
| | Additional Information URL |

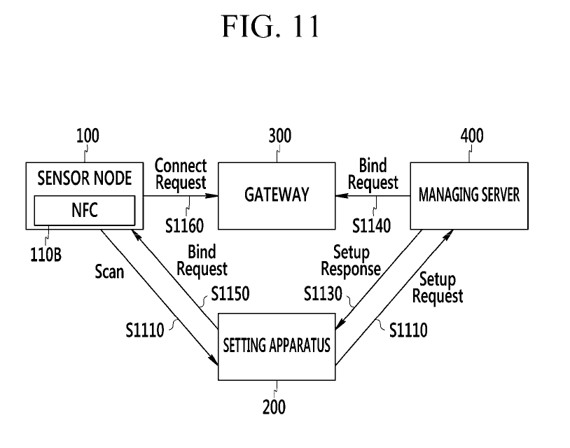

Hereinabove, the case in which the near field communication apparatus 110 is a passive tag such as the QR code has been described. In the case in which an active tag such as an NFC or an RFID is used as the near field communication apparatus 110, communication between the sensor node 100 and the setting apparatus 200 is possible. Therefore, the sensor node 100 rather than the gateway 300 may first perform a connect request. This method will be described with reference to FIG. 11. For convenience of explanation, the case in which the sensor node 100 includes an NFC 110B as an active tag will be described.

FIG. 11 is a diagram showing a method for setting a sensor node according to a third exemplary embodiment of the present invention.

First, the setting apparatus 200 obtains information on the sensor node 100 such as a sensor node ID, or the like, through tagging of the NFC 100B (S1110).

The setting apparatus 200 transmits a setup request message to the managing server 400 (S1120). The setup request message includes the same contents (information on a position of the setting apparatus, intension of the installer, or the like) as those of the setup request message of FIG. 2.

The managing server 400 transmits a setup response message to the setting apparatus 200 (S1130). Here, the setup response message includes information on a gateway with which the sensor node 100 is to connect.

Then, the managing server 400 transmits a bind request message, which is a message informing the gateway 300 that a new sensor node 100 will be connected with the gateway 300, to the gateway 300 (S1140).

The setting apparatus 200 receiving the setup response message from the managing server 400 performs communication with the NFC 110B, thereby transmitting the bind request message to the sensor node 100 (S1150). Here, the bind request message includes information (channel ID, PAN ID, network address, and the like) on the gateway 300 with which the sensor node 100 is to be connected.

Finally, the sensor node 100 transmits a connect request message to the gateway 300, thereby starting the connection (S1160).

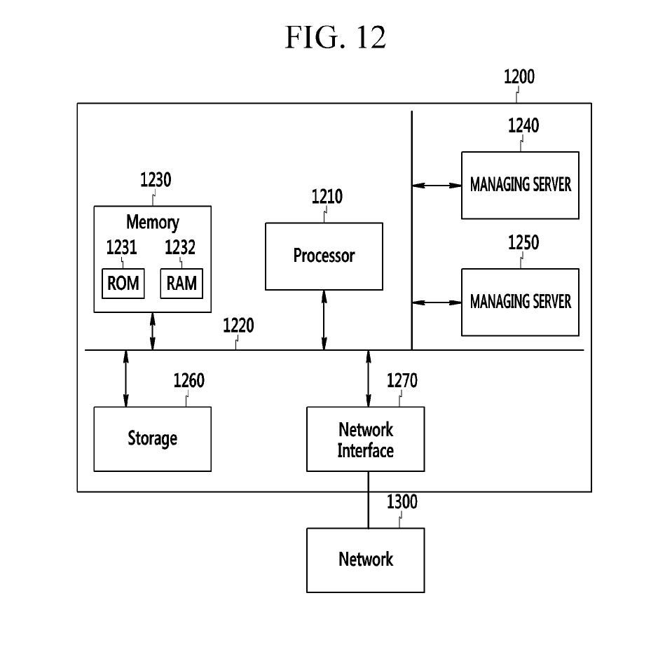

An embodiment of the present invention may be implemented in a computer system, e.g., as a computer readable medium. As shown in in FIG. 12, a computer system 1200 may include one or more of a processor 1210, a memory 1230, a user input device 1240, a user output device 1250, and a storage 1260, each of which communicates through a bus 1220. The computer system 1200 may also include a network interface 1270 that is coupled to a network 1300. The processor 1210 may be a central processing unit (CPU) or a semiconductor device that executes processing instructions stored in the memory 1230 and/or the storage 1260. The memory 1230 and the storage 1260 may include various forms of volatile or non-volatile storage media. For example, the memory may include a read-only memory (ROM) 1231 and a random access memory (RAM) 1232.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for setting a sensor node in a sensor network, comprising:
scanning, by a setting apparatus, the sensor node to obtain information on the sensor node;
selecting a gateway that is to be connected with the sensor node;
transmitting the information on the sensor node to the selected gateway; and
requesting, by the selected gateway, the sensor node to make a connection.

2. The method of claim 1, wherein
the sensor node includes a near field communication apparatus, and
the obtaining of the information on the sensor node includes scanning, by the setting apparatus, the near field communication apparatus to obtain the information on the sensor node.

3. The method of claim 1, wherein
the information on the sensor node includes an ID of the sensor node.

4. The method of claim 1, wherein
the selecting of the gateway includes:
obtaining a position of the sensor node; and
selecting the gateway that is to be connected with the sensor node using the obtained position.

5. The method of claim 4, further comprising
transmitting, by the setting apparatus, a setup request message to a managing server,
wherein the transmitting of the information on the sensor node includes transmitting, by the managing server, a bind request message to the selected gateway, and
the setup request message and the bind request message include the information on the sensor node.

6. The method of claim 1, wherein
the selecting of the gateway includes
scanning, by the setting apparatus, the gateway to select the gateway.

7. The method of claim 6, wherein
the transmitting of the information on the sensor node includes transmitting, by the setting apparatus, a bind request message to the selected gateway, and
the bind request message includes the information on the sensor node.

8. The method of claim 5, wherein
the setup request message further includes information on the setting apparatus,
the method further comprising: transmitting, by the managing server, an authentication code to the setting apparatus using the information on the setting apparatus; and
transmitting, by the setting apparatus, an acknowledge message including the authentication code to the managing server.

9. The method of claim 7, further comprising
transmitting, by the managing server, a passcode to the setting apparatus and the selected gateway,
wherein the bind request message further includes the passcode.

10. The method of claim 1, wherein
the requesting of the sensor node to make the connection includes:
transmitting, by the selected gateway, an invite request message to the sensor node;
transmitting, by the sensor node, a challenge message including a first random value to the selected gateway;
converting, by the selected gateway, the first random value and a secret key into a first hash value using a hash function;
transmitting, by the selected gateway, the first hash value to the setting apparatus; and
requesting, by the setting apparatus, the selected gateway to make a connection.

11. The method of claim 10, wherein
the invite request message includes a second random value, and
the requesting of the sensor node to make the connection further includes:
converting, by the sensor node, the second random value and the secret key into a second hash value using the hash function; and
transmitting, by the sensor node, the second hash value to the selected gateway.

12. The method of claim 1, wherein
the requesting of the sensor node to make the connection includes:
transmitting, by the selected gateway, an invite request message to the sensor node;
transmitting, by the setting apparatus, a challenge message including a random value and a connect message for a connection request to the selected gateway;
converting, by the selected gateway, the random value and a secret key into a hash value using a hash function; and
transmitting, by the selected gateway, the hash value and admittance of the connection to the setting apparatus.

13. The method of claim 1, wherein
the requesting of the sensor node to make the connection includes:
transmitting, by the gateway, a connect message to the sensor node;
transmitting, by the sensor node, a challenge message including a random value to the selected gateway;
converting, by the selected gateway, the random value and a secret key into a hash value using a hash function;
transmitting, by the selected gateway, the hash value to the setting apparatus; and
transmitting, by the setting apparatus, an admittance message to the selected gateway.

14. The method of claim 1, wherein
the requesting of the sensor node to make the connection includes:
transmitting, by the selected gateway, an invite request message to the sensor node;
transmitting, by the setting apparatus, a challenge message including a random value and a connect message for a connection request to the selected gateway;
converting, by the selected gateway, the random value and a first secret key into a hash value using a hash function;
encrypting a new session key different from the first secret key using the first secret key; and
transmitting, by the selected gateway, the hash value, the encrypted value, and admittance of the connection to the setting apparatus.

15. A sensor network system comprising:
a sensor node including a first near field communication apparatus;
a setting apparatus scanning the first near field communication apparatus to obtain information on the sensor node; and
a gateway connected with the sensor node using the information on the sensor node obtained by the setting apparatus.

16. The sensor network system of claim 15, wherein
the setting apparatus selects the gateway,
the sensor network system further comprising a managing server receiving information on the gateway and the information on the sensor node from the setting apparatus and transmitting a bind request message to the gateway,
the bind request message including the information on the sensor node.

17. The sensor network system of claim 15, wherein
the gateway includes a second near field communication apparatus, and
the setting apparatus scans the second near field communication apparatus to select the gateway and transmits the information on the sensor node to the gateway.

18. The sensor network system of claim 15, wherein
the information on the sensor node includes an ID of the sensor node and a secret key.

19. A method for setting a sensor node in a sensor network, comprising:
providing a sensor node including an active tag;
scanning, by a setting apparatus, the active tag to obtain information on the sensor node;
transmitting, by a managing server, information on a gateway with which the sensor node is to be connected to the setting apparatus;
transmitting, by the setting apparatus, a bind request message including the information on the gateway to the sensor node; and
transmitting, by the sensor node, a connect request message to the gateway using the information on the gateway.

20. The method of claim 19, further comprising
transmitting, by the managing server, a bind request message, which is a message informing the gateway that the sensor node performs a connection request, to the gateway.
